(19) United States
(12) Patent Application Publication
(10) Pub. No.: US 2012/0166165 A1
(43) Pub. Date: Jun. 28, 2012

(54) ROBOT SIMULATION APPARATUS, ROBOT SIMULATION METHOD, AND ROBOT SIMULATION PROGRAM

(75) Inventors: Taishi NOGAMI, Matsumoto (JP); Katsuji IGARASHI, Chino (JP)

(73) Assignee: SEIKO EPSON CORPORATION, Tokyo (JP)

(21) Appl. No.: 13/314,621

(22) Filed: Dec. 8, 2011

(30) Foreign Application Priority Data
Dec. 24, 2010 (JP) 2010-287873

(51) Int. Cl. G06G 7/48

(52) U.S. Cl. 703/6

(57) ABSTRACT

A robot simulation apparatus for moving a virtual robot along a track includes: a track calculating unit that performs, in an interrupt time interval, track calculation processing for calculating a track of the virtual robot after a sampling time; and a time changing unit that separately sets both of the sampling time and the interrupt time interval variable in a range in which the sampling time is equal to or shorter than the interrupt time interval.

### BACKGROUND

1. Technical Field

The present invention relates to an apparatus for simulating the movement of a robot, and, more particularly to a robot simulation apparatus, a robot simulation method, and a robot simulation program for simulating the movement of a robot using an operating system.

2. Related Art

In the past, as described in JP-A-2003-300185, a robot simulation apparatus for simulating the movement of a robot is known. FIG. 7 is a configuration diagram showing layer by layer an example of the configuration of the robot simulation apparatus on the basis of functions thereof. FIG. 8 is a diagram showing, together with the structure of a robot to be simulated, an example of a simulation performed by the robot simulation apparatus. FIG. 9 is a time chart showing the transition of processing executed by such a robot simulation apparatus.

As shown in FIG. 7, an apparatus body 50a of a robot simulation apparatus 50 is mounted with a processor 51, a memory 52, an OS 61, and application programs 71. A display unit 53 and an input unit 54 are connected to the apparatus body 50a.

A system timer 51a for setting timing of processing is incorporated in the processor 51. Robot data 52a for representing a virtual robot as an image is stored in the memory 52. The processor 51 reads out and interprets a robot simulation program 71a, which is one of the application programs 71, and converts a memory address of a robot controller into a memory address of the robot simulation apparatus 50 under the environment of the OS 61. Consequently, a virtual robot controller starts in the robot simulation apparatus 50. The virtual robot controller reads out the structure of the virtual robot, a type of an actuator, a start point of an action performed by the virtual robot, and an end point of the action performed by the virtual robot from the robot data 52a indicating the structure, the type, the start point, and the end point and calculates an optimum overall track connecting the start point and the end point. The virtual robot controller performs, in order, two kinds of processing explained below, i.e., track calculation processing and event processing in a time interval of the system timer 51a.

In the track calculation processing, first, a target position of a robot at a point when a predetermined sampling time elapses is set on the optimum overall track. An optimum track connecting a present position of the virtual robot and a target position of the virtual robot is calculated as a target track from the present position. Specifically, in the virtual robot controller, every time the track calculation processing is performed, a very small track from the present position is calculated and the optimum track is treated as a set of such tracks. As a result, irrespective of what kind of shape the optimum track forms, the robot moves along a track close to the optimum track.

In the event processing, first, unstationary and accidental states in the peripheral section of the virtual robot such as a state in which a work in a virtual space is set on a hand of the virtual robot and a state in which the virtual robot reaches a predetermined position are treated as events. Immediately after the track calculation processing is performed, such events are supplemented and processing for event driving is continuously performed on the basis of the supplemented events. As a result, the virtual robot moves along a track according to the unstationary and accidental states in the peripheral section of the virtual robot.

For example, when a simulation is performed in the robot simulation apparatus 50, as shown in FIG. 8, an action display screen 53a is displayed on the display unit 53 of the robot simulation apparatus 50. On this action display screen 53a, a virtual robot R to be simulated, a camera Ca that images a distal end of the virtual robot R in a virtual space, and a robot sensor Se that detects the position of the virtual robot R in the virtual space are displayed. The virtual robot R to be simulated is a vertical multi-joint robot or a scalar robot. Such a virtual robot R includes a robot body section Ra, which is a proximal end section, and a robot hand Rb, which is a distal end section.

The virtual robot controller calculates, with respect to the robot body section Ra, using the start point and the end point, an optimum track connecting the start point and the end point. Subsequently, the virtual robot controller performs the track calculation processing in a predetermined time interval to thereby sequentially update a track of the robot body Ra. Every time the virtual robot controller performs the track calculation processing, the virtual robot controller performs the event processing and supplements events in the peripheral section of the robot such as the robot hand Rb, the camera Ca, and the robot sensor Se. Until the robot body section Ra reaches the end point, the virtual robot controller repeatedly performs the track calculation processing and the event processing and continues to update an image of the virtual robot R on the action display screen 53a on the basis of results of the track calculation processing and the event processing.

In the robot simulation apparatus 50, an interrupt for performing the track calculation processing and the event processing is generated by a system call for monitoring the track calculation processing. Under the environment of the OS 61, a time interval of such a system interrupt is usually a minimum interrupt time interval by the system timer 51a. In this case, the minimum interrupt time interval by the system timer 51a is unconditionally set by the architecture of hardware resources such as the processor 51 and the memory 52. Therefore, a time interval of an interrupt in which the track calculation processing is performed is, for example, 2 milliseconds in one apparatus and, on the other hand, in some case, exceeds 10 milliseconds in another apparatus. After all, such a minimum time interval of the interrupt is different for each of the hardware resources on which a robot simulation program is mounted.

On the other hand, a sampling time used in the track calculation processing is a time peculiar to the robot simulation program and does not depend on the architecture of the hardware resources. In other words, whereas the time interval of the interrupt in which the track calculation processing is different for each of the hardware resources, a time in which sampling is performed in the track calculation processing is common among the hardware resources. Therefore, depending on the performance of the hardware resources, a large time difference occurs between the minimum interrupt time interval and the sampling time. As a result, it is likely that a result of the robot simulation is obtained as explained below.

For example, as shown in FIG. 9, when the performance of the hardware resources is low and a minimum interrupt time interval Ts is substantially larger than a sampling time Tp, while the minimum interrupt time interval Is elapses on an actual time axis, only the sampling time Tp elapses on a time axis in the virtual robot controller. As a result, a time required for the simulation itself increases and, moreover, the movement of the virtual robot R displayed on the display unit 53 slows down. Eventually, the movement of the robot controlled by an actual robot controller and the movement of the virtual robot are substantially different from each other.

### SUMMARY

An advantage of some aspects of the invention is to provide a robot simulation apparatus, a robot simulation method, and a robot simulation program that can prevent results of a simulation from being different from one another depending on hardware resources for performing the simulation and reduce a difference in a result of the simulation among the hardware resources.

An aspect of the invention is directed to a robot simulation apparatus for moving a virtual robot along a track including: a track calculating unit that performs, in an interrupt time interval, track calculation processing for calculating a track of the virtual robot after a sampling time; and a time changing unit that separately sets both of the sampling time and the interrupt time interval variable in a range in which the sampling time is equal to or shorter than the interrupt time interval.

When the track calculation processing is performed in a predetermined interrupt time interval, a time equivalent to the interrupt time interval elapses on an actual time axis and the sampling time elapses on a time axis of the virtual robot. Therefore, if the track calculation processing is performed in a minimum interrupt time interval based on hardware resources, a time difference between the interrupt time interval and the sampling time is different for each of the hardware resources. If the minimum interrupt time interval based on the hardware resources is extremely large, every time an interrupt occurs, the time of the virtual robot lags behind the actual time by a difference (Ti−Tp) between the interrupt time interval (Ti) and the sampling time (Tp). As a result, a time required for a simulation itself increases and, moreover, the movement of a robot, which is a result of the simulation, also slows down.

According to the aspect of the invention, the sampling time (Tp) and the interrupt time interval (Ti) are variable in a range in which the sampling time (Tp) is equal to or shorter than the interrupt time interval (Ti). Therefore, for example, when the minimum interrupt time interval by the hardware resources is relatively long, it is possible to increase the interrupt time interval and increase the sampling time according to the interrupt time interval. Consequently, it is possible to reduce the difference (Ti−Tp) between the interrupt time interval and the sampling time.

Like the minimum interrupt time interval, a processing time required for the track calculation processing is different for each of the hardware resources. Therefore, for example, when the speed of track calculation by the hardware resources is relatively low, it is possible to relatively increase the sampling time and set a long interrupt time interval different from the minimum interrupt time interval according to the sampling time.

As a result, it is possible to provide a robot simulation apparatus that can prevent results of a simulation from being different from one another depending on hardware resources for performing the simulation and reduce a difference in a result of the simulation among the hardware resources.

In the aspect of the invention, the time changing unit separately sets both of the sampling time and the interrupt time interval variable in a range in which the sampling time is equal to or shorter than a half of the interrupt time interval. The track calculating section equalizes the number of times of the track calculation processing performed in the interrupt time interval and an integer part of a value obtained by dividing the interrupt time interval by the sampling time.

According to the aspect of the invention, every time an interrupt occurs, the track calculation processing is performed plural times. The number of times of the track calculation processing performed in the interrupt time interval and the integer part of the value obtained by dividing the interrupt time interval by the sampling time are the same. Therefore, the interrupt time interval elapses on the actual time axis and, on the other hand, the sampling time is added plural times on the time axis of the virtual robot. Consequently, a difference between the elapsed time on the actual time axis and the elapsed time on the time axis of the virtual robot is surely smaller than the sampling time. Therefore, it is possible to surely prevent the time required for the simulation itself from increasing and prevent the movement of the virtual robot, which is a result of the simulation, from slowing down.

In the aspect of the invention, the time changing unit sets the sampling time and the interrupt time interval variable such that the interrupt time interval is an integer times as long as the sampling time.

According to the aspect of the invention, every time an interrupt occurs, a time equivalent to the interrupt time interval elapses on the actual time axis and the sampling time is added plural times on the time axis of the virtual robot. In this case, since the interrupt time interval (Ti) is an integer times (K times) as long as the sampling time (Tp), the elapsed time (Ti) on the actual time axis and the elapsed time (Tp×K) on the time axis of the virtual robot are the same. Therefore, it is possible to more surely prevent the time required for the simulation itself from increasing and prevent the movement of the virtual robot, which is a result of the simulation, from slowing down.

In the aspect of the invention, the virtual robot includes a robot body section, which is a target of the track calculation processing, and a robot peripheral section forming the periphery of the robot body section. The robot simulation apparatus further includes an event processing unit that performs, for each the track calculation processing and following the track calculation processing, event processing for processing a grasp of a state with respect to the robot peripheral section as an event.

If the interrupt time interval and the sampling time are the same (Ti=Tp) in the time changing unit, it is possible to set at least the actual time axis and the time axis of the virtual robot the same and prevent a result of the simulation from being different depending on the hardware resources. However, if the interrupt time interval and the sampling time are set the same (Ti=Tp), when the interrupt time interval (Ti) is large, a time difference between the processing time required for the track calculation processing and the sampling time (Tp(=Ti)) is also large. As a result, a time until the sampling time (Tp) of the track calculation processing elapses after the processing time of the track calculation processing elapses also increases. The number of events that occur during this time also increases. This makes it difficult to supplement such events.

In this regard, according to the aspect of the invention, every time the track calculation processing is performed, the event processing is performed following the track calculation processing. Therefore, even when the sampling time (Tp) increases, events that occur in the sampling time can be supplemented in the event processing after the sampling time. If the track calculation processing is performed plural times in one interrupt, the sampling time of the track calculation processing decreases by the number of times the track calculation processing is performed. Therefore, it is possible to reduce a time until the sampling time elapses after the processing time of the track calculation processing elapses and reduce events that occur during this time. Therefore, events are more surely supplemented in the event processing after the track calculation processing.

In the aspect of the invention, the robot body section is plural arms coupled by joints. The robot peripheral section includes a robot hand coupled to a distal end of the robot body section, a camera that images the robot hand, and a sensor that detects the position of the robot hand.

According to the aspect of the invention, it is possible to prevent, while surely supplementing events supplemented from the robot hand, the camera, and the sensor, results of the simulation from being different from one another depending on the hardware resources for performing the simulation.

Another aspect of the invention, is directed to a robot simulation method for moving a virtual robot along a track including: performing, in an interrupt time interval, track calculation processing for calculating a track of the virtual robot after a sampling time; and separately setting both of the sampling time and the interrupt time interval variable in a range in which the sampling time is equal to or shorter than the interrupt time interval.

According to the aspect of the invention, the sampling time (Tp) and the interrupt time interval (Ti) are variable in a range in which the sampling time (Tp) is equal to or shorter than the interrupt time interval (Ti). Therefore, for example, when the minimum interrupt time interval by the hardware resources is relatively long, it is possible to increase the interrupt time interval and increase the sampling time according to the interrupt time interval. Consequently, it is possible to reduce the difference between the interrupt time interval and the sampling time.

Like the minimum interrupt time interval, a processing time required for the track calculation processing is different for each of the hardware resources. Therefore, for example, when the speed of track calculation by the hardware resources is relatively low, it is possible to relatively increase the sampling time and set a long interrupt time interval different from the minimum interrupt time interval according to the sampling time.

As a result, it is possible to provide a robot simulation method that can prevent results of a simulation from being different from one another depending on hardware resources for performing the simulation and reduce a difference in a result of the simulation among the hardware resources.

Still another aspect of the invention is directed to a robot simulation program for causing a computer for moving a virtual robot along a track to function as: a track calculating unit that performs, in an interrupt time interval, track calculation processing for calculating a track after a sampling time of the virtual robot; and a time changing unit that separately sets both of the sampling time and the interrupt time interval variable in a range in which the sampling time is equal to or shorter than the interrupt time interval.

According to the aspect of the invention, the sampling time (Tp) and the interrupt time interval (Ti) are variable in a range in which the sampling time (Tp) is equal to or shorter than the interrupt time interval (Ti). Therefore, for example, when the minimum interrupt time interval by the hardware resources is relatively long, it is possible to increase the interrupt time interval and increase the sampling time according to the interrupt time interval. Consequently, it is possible to reduce the difference (Ti−Tp) between the interrupt time interval and the sampling time.

Like the minimum interrupt time interval, a processing time required for the track calculation processing is different for each of the hardware resources. Therefore, for example, when the speed of track calculation by the hardware resources is relatively low, it is possible to relatively increase the sampling time and set a long interrupt time interval different from the minimum interrupt time interval according to the sampling time.

As a result, it is possible to provide a robot simulation program that can prevent results of a simulation from being different from one another depending on hardware resources for performing the simulation and reduce a difference in a result of the simulation among the hardware resources.

### BRIEF DESCRIPTION OF THE DRAWINGS

The invention will be described with reference to the accompanying drawings, wherein like numbers reference like elements.

FIG. 1 is a configuration diagram showing layer by layer the configuration of a robot simulation apparatus according to an embodiment of the invention on the basis of functions.

FIG. 2 is a diagram showing a condition input screen in the robot simulation apparatus according to the embodiment.

FIG. 3 is a flowchart for explaining the order of processing performed in a robot simulation method according to the embodiment.

FIG. 4 is a flowchart showing the order of processing performed in action display processing according to the embodiment.

FIG. 5 is a time chart showing the transition of the processing performed in the robot simulation method according to the embodiment.

FIG. 6 is a time chart showing the transition of processing performed in a robot simulation method according to a modification.

FIG. 7 is a configuration diagram showing layer by layer the configuration of a robot simulation apparatus according to a related art on the basis of functions.

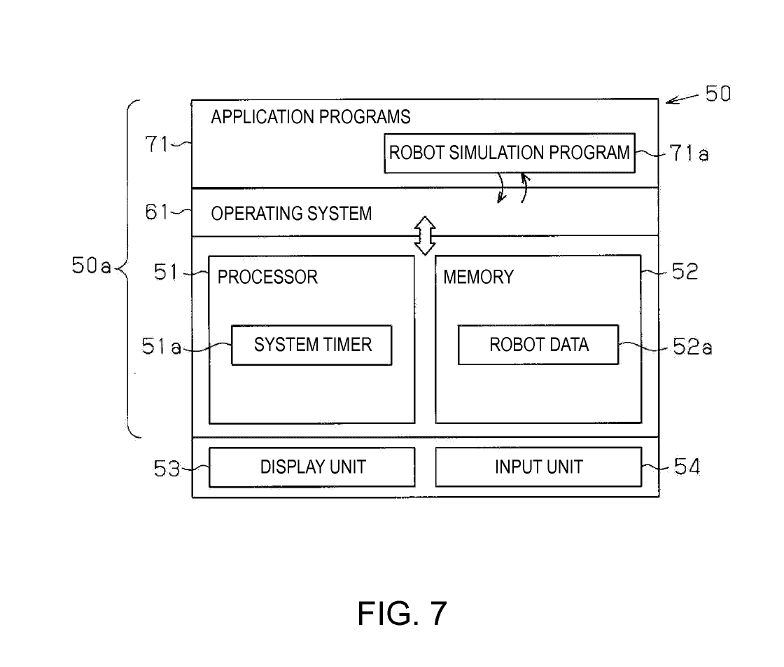

FIG. 8 is a configuration diagram showing the external appearance of the robot simulation apparatus together with the structure of a robot.

FIG. 9 is a time chart showing the transition of processing performed in the robot simulation apparatus according to the related art.

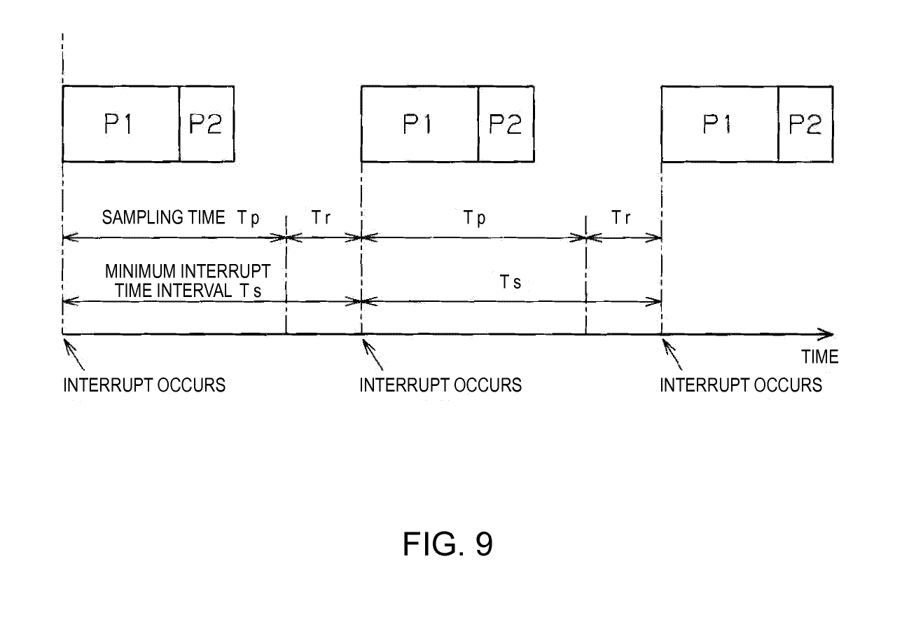

### DESCRIPTION OF EXEMPLARY EMBODIMENTS

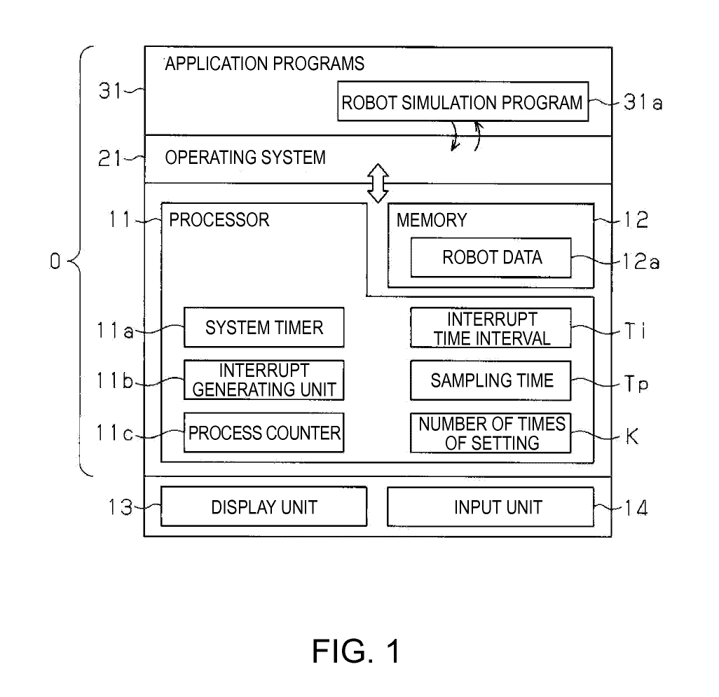

A robot simulation apparatus, a robot simulation method, and a robot simulation program according to an embodiment of the invention are explained below with reference to FIGS. 1 to 5.

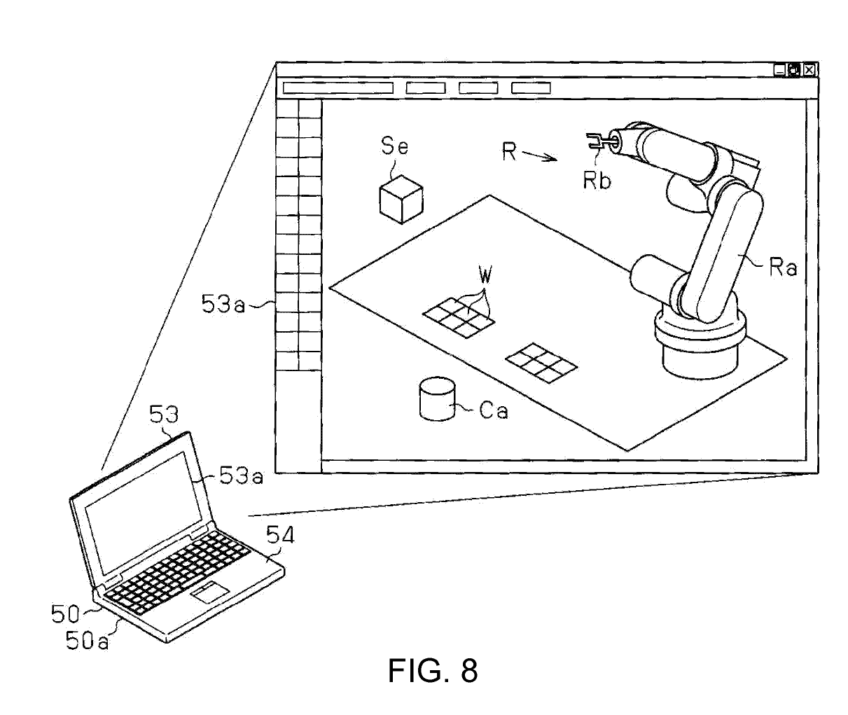

The external appearance of the robot simulation apparatus according to this embodiment is the same as the external appearance shown in FIG. 8. The configuration of a robot to be simulated is a vertical multi-joint robot same as the robot shown in FIG. 8. Therefore, in the following explanation, explanation concerning the external appearance of the robot simulation apparatus and the configuration of the robot to be simulated is omitted.

### Robot Simulation Apparatus

First, the configuration of the robot simulation apparatus is explained with reference to FIG. 1.

As shown in FIG. 1, the robot simulation apparatus is a computer in which an input unit 14 and a display unit 13 are connected to an apparatus body 10 mounted with a processor 11, a memory 12, an OS 21, and application programs 31.

The processor 11 is mounted with a system timer 11a, an interrupt generating unit 11b that generates an interrupt, and a process counter 11c that counts the number of times processing is performed. The processor 11 reads out and interprets a robot simulation program 31a, which is one of the application programs 31, and converts a memory address of a robot controller into a memory address of the robot simulation apparatus under the environment of the OS 21. Consequently, a virtual robot controller starts in the robot simulation apparatus.

An interrupt command for starting a simulation is input to the input unit 14. Various data such as an interrupt time interval Ti, a sampling time Tp, and robot data 12a are input to the input unit 14.

The interrupt time interval Ti is a time interval equal to or longer than a minimum interrupt time interval by the system timer 11a. The input unit 14 inputs the interrupt time interval Ti satisfying this condition to the apparatus body 10. The sampling time Tp is a time equal to or shorter than the interrupt time interval Ti. The input unit 14 inputs the sampling time Tp satisfying this condition to the apparatus body 10.

The robot data 12a includes, for example, a mechanical structure of a virtual robot R set as a target to be simulated, a type of an actuator included in the virtual robot R, a reduction gear ratio of a reduction gear included in the virtual robot R, and a start point and an end point of an action of a robot body section Ra. When the virtual robot controller represents the posture of the virtual robot R and the movement of the virtual robot R in a virtual space, the virtual robot controller uses the robot data 12a.

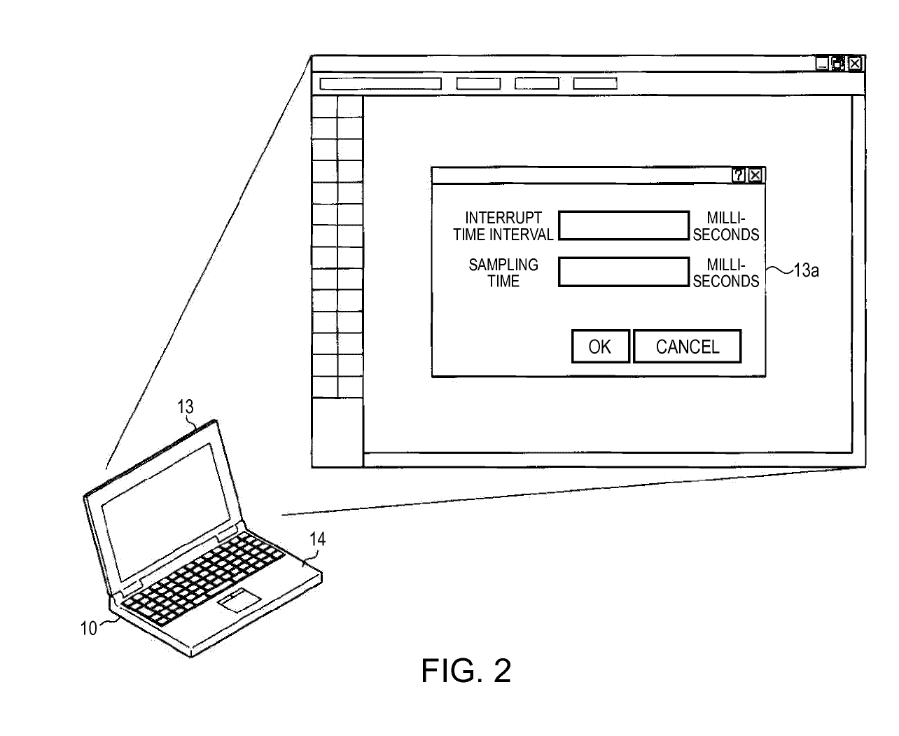

The display unit 13 displays a data input screen for inputting the robot data 12a and a condition input screen 13a (see FIG. 2) for inputting the interrupt time interval Ti and the sampling time Tp. The display unit 13 displays a still image of the virtual robot R based on the robot data 12a and displays, as a moving image, the movement of the virtual robot R, which is a result or the robot simulation.

The interrupt time interval Ti input on the condition input screen 13a and the sampling time Tp also input on the condition input screen 13a are stored in a register of the processor 11. An integer part of a division result obtained by dividing the interrupt time interval Ti by the sampling time Tp is stored in the register of the processor 11 as the set number of times K, which is a setting value of the number of times processing is performed. On the other hand, the robot data 12a input on the data input screen is stored in the memory 12.

The processor 11 reads out the robot data 12a stored in the memory 12 and calculates an optimum overall track connecting a start point of an action of the robot body section Ra and an end point of the action of the robot body section Ra. The processor 11 displays an image of the virtual robot R on the display unit 13 and causes the interrupt generating unit 11b to generate an interrupt in each interrupt time interval Ti. Every time an interrupt is generated by the interrupt generating unit 11b, the processor 11 performs track calculation processing and event processing in order according to the robot simulation program 31a. Further, every time an interrupt is generated by the interrupt generating unit 11b, the processor 11 resets a value counted by the process counter 11c. Every time the track calculation processing and the event processing are performed, the processor 11 increments the value counted by the process counter 11c.

As explained above, in the track calculation processing, first, a target position of the robot body section Ra at a point when the predetermined sampling time Tp elapses is set on the optimum overall track. An optimum track connecting a start position, which is the position of the robot body section Ra at a point when the track calculation processing is started, and the target position of the robot body section Ra is calculated as a target track in the present track calculation processing. In other words, in the virtual robot controller, every time the track calculation processing is performed, a very small track from the start position of the track calculation processing is calculated. The optimum track is treated as a set of such tracks.

As explained above, in the event processing, first, unstationary and accidental states in the peripheral section of the virtual robot R such as a state in which a work W is set on the robot hand Rb and a state in which the robot body section Ra reaches a predetermined position are treated as events. Immediately after the track calculation processing is performed, the events are supplemented and processing for event driving is continuously performed on the basis of the supplemented events.

### Robot Simulation Method

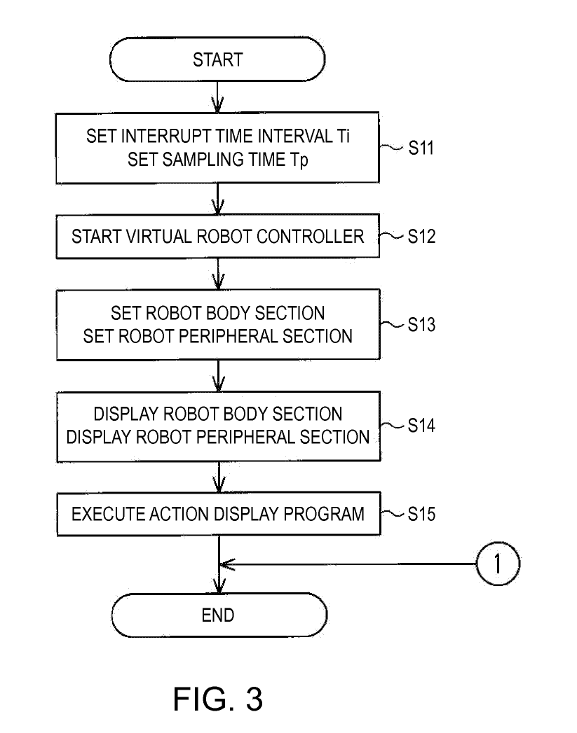

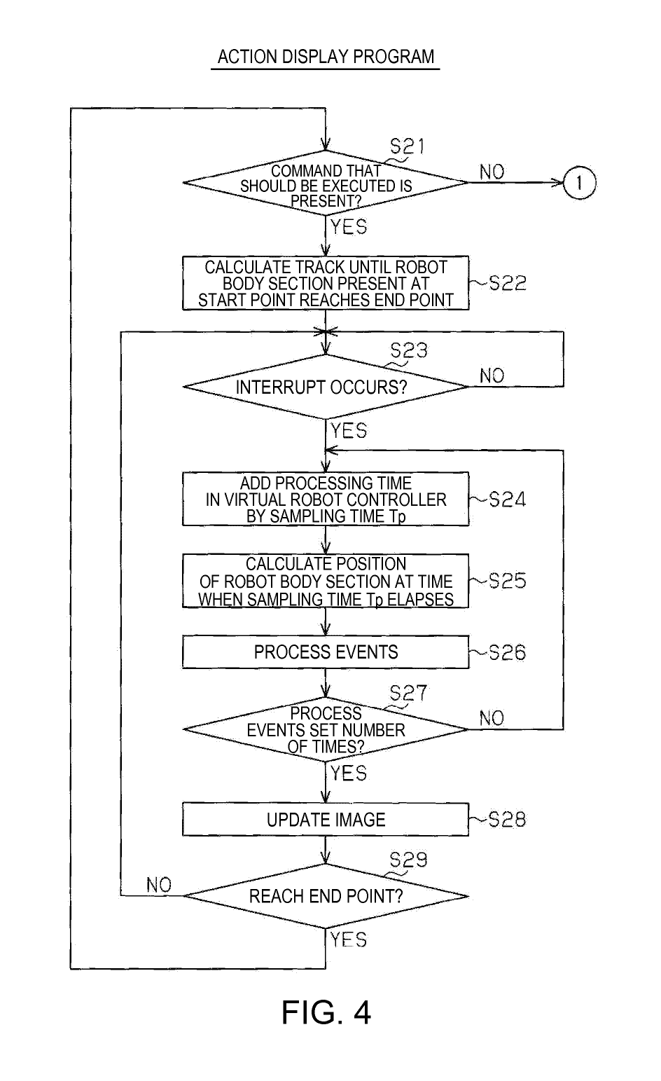

The action of the robot simulation apparatus are explained together with a robot simulation method performed in the robot simulation apparatus with reference to FIGS. 3 and 4. First, the order of processing in the entire robot simulation method is explained and then the order of processing in displaying a result of a simulation in the robot simulation method is explained.

When an interrupt command for performing a robot simulation is input from the input unit 14 to the apparatus body 10, as shown in FIG. 3, the processor 11 sets the interrupt time interval Ti and the sampling time Tp (step S11: a time changing process). Specifically, the processor 11 reads out and interprets an interrupt time interval setting program included in the robot simulation program 31a. Subsequently, the processor 11 displays, on the display unit 13, the condition input screen 13a for the input unit 14 to input the interrupt time interval Ti and the sampling time Tp. Consequently, the interrupt time interval Ti and the sampling time Tp are separately variable from initial values without being involved in each other.

Thereafter, the input unit 14 inputs the interrupt time interval Ti and the sampling time Tp in the apparatus body 10 on the basis of the condition input screen 13a. The processor 11 stores the input interrupt time interval Ti and the input sampling time Tp in the register to thereby end the setting of the interrupt time interval Ti and the sampling time Tp.

Subsequently, the processor 11 reads out and interprets a controller starting program included in the robot simulation program 31a. The processor 11 converts a memory address of the robot controller into a memory address of the robot simulation apparatus. Consequently, the virtual robot controller starts in the robot simulation apparatus (step S12).

The processor 11 reads out and interprets a root data setting program included in the robot simulation program 31a. The processor 11 displays, on the display unit 13, a data input screen for inputting the robot data 12a to the input unit 14. Thereafter, when the robot data 12a is input on the data input screen, the processor 11 stores the robot data 12a in a memory address corresponding to the memory address of the robot controller and ends the setting of the robot data 12a (step S13).

When the interrupt time interval Ti, the sampling time Tp, and the robot data 12a are set in this way, the processor 11 displays, on the basis of the set robot data 12a, an image of the robot body section Ra and an image of the robot peripheral section on the display unit 13 serving as a virtual space (step S14). When an interrupt command for displaying an action of the virtual robot R is input from the input unit 14, the processor 11 reads out and interprets an action display program included in the robot simulation program 31a and executes the action display program (step S15).

The order of processing in the action display program is explained below. As shown in FIG. 4, in the action display program, first, the processor 11 determines, referring to a program counter and the like, whether a command that should be executed is present (step S21). When no command that should be executed is present (NO in step S21), the processor 11 ends the action display program and ends the robot simulation according to the end of the action display program. On the other hand, when a command that should be executed is present (YES in step S21), the processor 11 reads out a start point of an action of the robot body section Ra and an end point of the action of the robot body section Ra from the robot data 12a and calculates an optimum track until the robot body section Ra located at the start point reaches the end point (step S22). In calculating the optimum track, the processor 11 calculates the optimum track from the start point to the end point on the basis of various conditions set in advance such as a condition that the robot body section Ra moves on a shortest track and a condition that a track of the robot body section Ra have a curvature equal to or larger than a predetermined curvature. The processor 11 stays on standby until an interrupt is generated by the interrupt generating unit 11b (NO in step S23).

Subsequently, when an interrupt is generated by the interrupt generating unit 11b (YES in step S23), the processor 11 resets the value counted by the process counter 11c. The processor 11 adds the sampling time Tp to a processing time based on a time axis of the virtual robot controller (step S24). The processor 11 continuously executes the track calculation processing and the event processing.

Specifically, the processor 11 sets, on the optimum track, the position of the robot body section Ra at a point when the sampling time Tp elapses. The processor 11 treats the position set in this way as a target position in the present track calculation processing. Subsequently, the processor 11 acquires a start position, which is the position of the robot body section Ra at a point when the present track calculation processing is started. The processor 11 calculates, as a target track in the present track calculation processing, an optimum track connecting the target position of the robot body section Ra and the start position (step S25: a track calculating step). The processor 11 grasps a state of the robot peripheral section on the basis of the events and performs processing for event driving on the basis of the supplemented events (step S26).

When each of the track calculation processing and the event processing is performed once, the processor 11 increments a value counted by the process counter 11c. The processor 11 repeats in order the processing for adding the sampling time Tp (step S24), the track calculation processing (step S25), and the event processing (step S26) in order until the value counted by the process counter 11c reaches a set number of times K (NO in step S27).

Subsequently, when the value counted by the process counter 11c reaches the set number of times K (YES in step S27), the processor 11 updates, on the display unit 13, the image of the virtual robot R on the basis of target tracks calculated in track calculation processing performed K times (step S28). The processor 11 determines whether the robot body section Ra reaches the end point. When the robot body section Ra does not reach the end point, the processor 11 stays on standby until the next interrupt is generated (NO in step S29, step S23). On the other hand, when the robot body section Ra reaches the end point, the processor 11 determines again whether a command that should be executed is present (YES in step S29, step S21).

### Transition of Processing

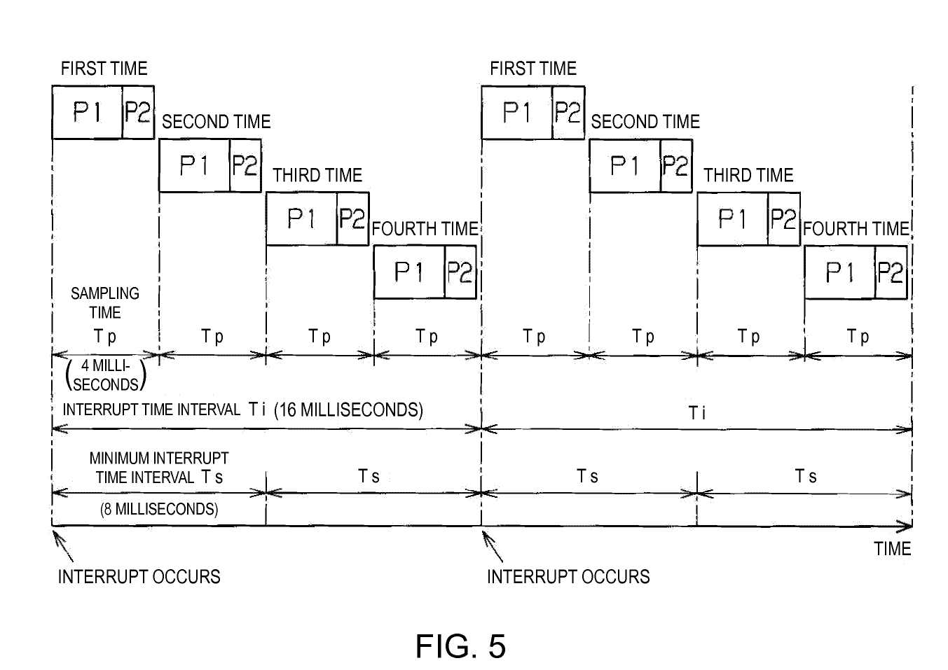

The transition of processing performed in the robot simulation method is explained with reference to FIG. 5. In order to particularly explain the transition of the track calculation processing and the event processing performed in one interrupt time interval in the transition of processing performed in the robot simulation method, in an example shown in FIG. 5, the interrupt time interval Ti and the sampling time Tp satisfy Expressions (1) and (2) below.

Ti=2×Ts=16 milliseconds (1)

Ti=K×Tp(K=4) (2)

Specifically, in a form shown in FIG. 5, the minimum interrupt time interval Ts of the system timer 11a is 8 milliseconds and the interrupt time interval Ti is 16 milliseconds, which is twice as long as the minimum interrupt time interval Ts. In the form shown in FIG. 5, the set number of times K is four and a value obtained by multiplying the set number of times K and the sampling time Tp together is the interrupt time interval Ti, i.e., the sampling time Tp is 4 milliseconds.

As shown in FIG. 5, when an interrupt is generated by the interrupt generating unit 11b, in the virtual robot controller, 4 milliseconds, which is the sampling time Tp, is added to the processing time, which is the time axis of the virtual robot controller. First track calculation processing P1 and first event processing P2 are continuously performed. Specifically, in the track calculation processing P1, a target track after 4 milliseconds, which is the sampling time Tp, is calculated. The track calculation processing P1 and the event processing P2 are performed while the sampling time Tp elapses on the actual time axis. When the sampling time Tp elapses on the actual time axis, in the virtual robot controller, the sampling time Tp is further added to the processing time and second track calculation processing P1 and second event processing P2 are continuously executed. Thereafter, every time the sampling time Tp elapses, in the virtual robot controller, the sampling time Tp is added to the processing time and the track calculation processing P1 and the event processing P2 are continuously executed.

As in the robot simulation apparatus in the past, it is assumed that the track calculation processing P1 is performed once in every minimum interrupt time interval Ts (8 milliseconds). In this case, while the minimum interrupt time interval Ts elapses on the actual time axis, only the sampling time Tp elapses on the time axis in the virtual robot controller. Specifically, every time an interrupt occurs, a time in the virtual robot controller lags behind the actual time by 4 milliseconds. Therefore, a time required for the simulation itself increases and even the movement of the virtual robot R displayed on the display unit 13 slows down. Eventually, the movement of the robot controlled by an actual robot controller and a result of the simulation are substantially different from each other.

In this regard, in the robot simulation apparatus, every time an interrupt occurs, the track calculation processing P1 is performed the set number of times K. With such a configuration, while the interrupt time interval Ti (16 milliseconds) elapses, the sampling time Tp (4 milliseconds) is added by the set number of times (four times) on the time axis in the virtual robot controller. In other words, while 16 milliseconds elapses on the actual time axis, 16 milliseconds also elapses on the time axis in the virtual robot controller. Therefore, it is possible to prevent the time required for the simulation itself from increasing and prevent the movement of the virtual robot R displayed on the display unit 13 from slowing down. Eventually, it is possible to make the movement of the robot controlled by the actual robot controller and the result of the simulation similar to each other.

Moreover, in the robot simulation apparatus, the simulation is performed in the interrupt time interval Ti (16 milliseconds) different from the minimum interrupt time interval Ts (8 milliseconds). Therefore, for example, even when the minimum interrupt time interval Ts by other hardware resources is longer than 8 milliseconds, it is possible to set the interrupt time interval Ti longer than the minimum interrupt time interval Ts and set the sampling time Tp long according to the interrupt time interval Ti. For example, when the speed of track calculation by the other hardware resources is relatively low, it is possible to set the sampling time Tp relatively long and set the interrupt time interval Ti different from the minimum interrupt time interval Ts longer according to the sampling time Tp. Consequently, it is possible to reduce a difference between a total of the sampling time Tp required for an interrupt and the interrupt time interval Ti. Therefore, it is possible to obtain effects equivalent to the effects explained above irrespective of whether the minimum interrupt time interval Ts is larger than 8 milliseconds, the minimum interrupt time interval Ts is smaller than 8 milliseconds, and the speed of calculation is low depending on hardware resources.

Thereafter, when each of the track calculation processing P1 and the event processing P2 is performed four times, which is the set number of times K, 16 milliseconds, which is the interrupt time interval Ti, elapses and the next interrupt is generated by the interrupt generating unit 11b. When an interrupt is generated by the interrupt generating unit 11b, in the virtual robot controller, the sampling time Tp is added to the processing time again and the first track calculation processing P1 and the first event processing P2 are continuously executed.

As explained above, with the robot simulation apparatus, the robot simulation method, and the robot simulation program according to this embodiment, effects listed below are obtained.

(1) The processor 11 samples a track of the virtual robot R for the sampling time Tp. The processor 11 functions as a track calculating unit that performs the track calculation processing P1 in the interrupt time interval Ti. The apparatus body 10 function as a time changing unit that separately sets both of the sampling time Tp and the interrupt time interval Ti variable in a range in which the sampling time Tp is equal to or shorter than the interrupt time interval Ti.

With such a configuration, for example, when the minimum interrupt time interval Ts by the other hardware resources is relatively long, it is possible to increase the variable interrupt time interval Ti to be longer than the minimum interrupt time interval Ts and increase the variable sampling time Tp according to the interrupt time interval Ti. Consequently, it is possible to reduce a difference (Ti−Tp) between the interrupt time interval Ti and the sampling time Tp.

(2) For example, when the speed of calculation by the other hardware resources is relatively low, it is possible to increase the variable sampling time Tp to a degree enough for calculating a track and set the variable interrupt time interval Ti to be equal to or longer than the sampling time Tp.

As a result, it is possible to prevent a result of the simulation from being different depending on the hardware resources and reduce a difference in a result of the simulation among the hardware resources.

(3) In the processor 11, every time an interrupt occurs, the track calculation processing P1 is performed the set number of times K. In this case, the track calculation processing P1 is performed such that the number of times of the track calculation processing P1 performed in the interrupt time interval Ti and an integer part of a value obtained by dividing the interrupt time interval Ti by the sampling time Tp (the set number of times K) are the same. Therefore, the interrupt time interval Ti elapses on the actual time axis and the sampling time Tp is added the set number of times K on the time axis of the virtual robot R. Consequently, a difference between an elapsed time on the actual time axis and an elapsed time on the time axis of the virtual robot R is surely smaller than the sampling time Tp. Therefore, it is possible to surely prevent the time required for the simulation itself from increasing and prevent the movement of the virtual robot R, which is a result of the simulation, from slowing down.

(4) In the robot simulation apparatus, every time an interrupt occurs, a time equivalent to the interrupt time interval elapses on the actual time axis and the sampling time Tp is added the set number of times on the time axis of the virtual robot R.

In this case, since the interrupt time interval Ti is an integer times (the set number of times K times) as long as the sampling time Tp, the elapsed time on the actual time axis and the elapsed time on the time axis of the virtual robot R are the same. Therefore, it is possible to more surely prevent the time required for the simulation itself from increasing and prevent the movement of the virtual robot, which is a result of the simulation, from slowing down.

(5) The processor 11 processes, for each track calculation processing P1, a grasp of a state with respect to the robot peripheral section as an event. The processor 11 functions as an event processing unit that performs such event processing P2 following the track calculation processing P1. Therefore, even when the sampling time Tp is long, it is possible to supplement events, which occur in the sampling time Tp, in the event processing P2 after the sampling time Tp.

Since the track calculation processing P1 is performed the set number of times K in one interrupt, it is possible to reduce the sampling time Tp of the track calculation processing P1 by the set number of times K the track calculation processing P1 is performed. Therefore, it is possible to reduce a time until the sampling time Tp elapses after the processing time of the track calculation processing P1 elapses and reduce events that occur during this time. Therefore, events are more surely supplemented in the event processing P2 immediately after the track calculation processing P1.

The embodiment can also be carried out in forms explained below.

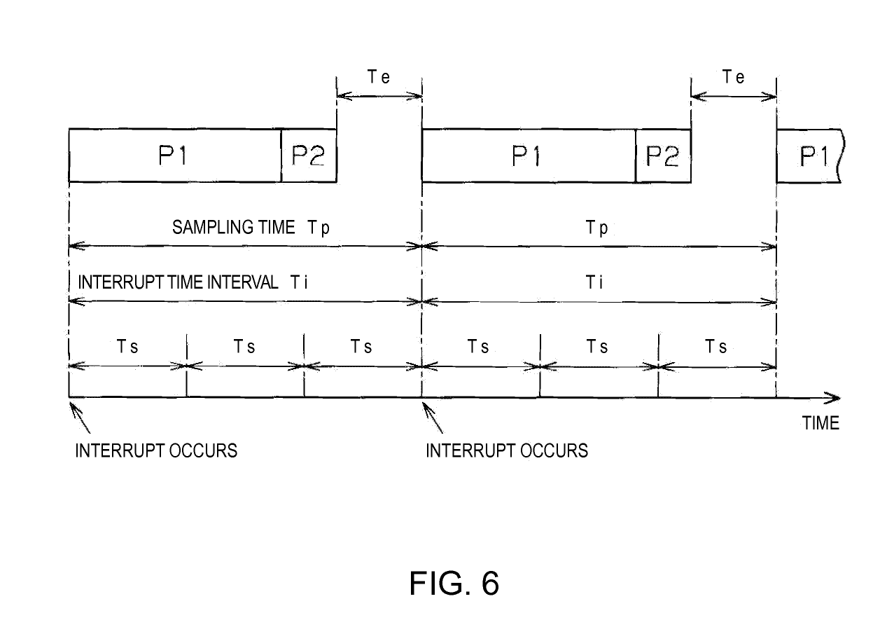

In the example explained in the embodiment, the set number of times K is “4”. However, the set number of times K is not limited to this and may be an integer other than “4”. FIG. 6 is a timing chart corresponding to FIG. 5 explained in the embodiment. In FIG. 6, the set number of times K is “1”.

As shown in FIG. 6, even when the set number of times K is “1”, it is possible to increase the sampling time Tp according to the interrupt time interval Ti. It is possible to set the long interrupt time interval Ti different from the minimum interrupt time interval Ts and set the sampling time Tp corresponding to the interrupt time interval Ti. With such a configuration, although a target track for each kind of track calculation processing is long, it is possible to prevent a result of the simulation from being different depending on the hardware resources and reduce a difference in a result of the simulation among the hardware resources.

In the configuration explained above, when the interrupt time interval Ti increases, a time difference between the processing time required for the track calculation processing P1 and the sampling time Tp(=Ti) also increases. As a result, a time Te until the sampling time Tp of the track calculation processing P1 elapses after the processing time of the track calculation processing P1 elapses also increase. The number of events that occur during this time Te also increases. Therefore, a configuration for performing the event processing plural times after performing the track calculation processing P1 is desirable.

The robot simulation apparatus and the robot simulation program only have to be configured to set the interrupt time interval Ti input by the input unit 14 to a value equal to or larger than the minimum interrupt time interval Ts. The robot simulation apparatus and the robot simulation program only have to be configured to set the sampling time Tp input by the input unit 14 to a value equal to or larger than the interrupt time interval Ti.

The set number of times K is set variable, whereby the interrupt time interval Ti may be set variable separately from the sampling time Tp. For example, the interrupt time interval Ti may be a computed value computed by the processor 11 on the basis of the sampling time Tp and the set number of times K. In this case, the sampling time Tp and the set number of times of K may be separately input from the input unit 14. The processor 11 may multiply together the sampling time Tp, which is an input value, and the set number of times K, which is an input value and store a result of the multiplication in the register as the interrupt time interval Ti.

The set number of times K is set variable, whereby the sampling time Tp may be set variable separately from the interrupt time interval Ti. For example, the sampling time Tp may be a computed value computed by the processor 11 on the basis of the interrupt time interval Ti and the set number of times K. In this case, the interrupt time interval Ti and the set number of times of K may be input from the input unit 14. The processor 11 may divide the interrupt time interval Ti, which is an input value, by the set number of times K, which is an input value, and store a result of the division in the register as the sampling time Tp.

The robot simulation apparatus and the robot simulation program may be configured such that, when the interrupt time interval Ti input by the input unit 14 is not an integer times as long as the sampling time Tp input by the input unit 14, an integer part of a quotient obtained by dividing the interrupt time interval Ti by the sampling time Tp is stored in the processor 11 as the set number of times K. The robot simulation apparatus and the robot simulation program may be configured such that an integer smaller than the integer part is stored as the set number of times K.

The event processing P2 may be performed by the processor 11 every time plural kinds of the track calculation processing P1 are performed. Alternatively, the event processing P2 may be performed by the processor 11 in a predetermined time interval irrespective of whether the track calculation processing P1 is performed. Further, the robot simulation apparatus and the robot simulation program may be configured not to perform the event processing P2.

The robot body section Ra may include the robot hand Rb besides, for example, arms coupled by joints. The robot body section Ra only has to be a section to be subjected to track calculation in the virtual robot R. The robot peripheral section may be, for example, a sensor that monitors opening and closing of a door in a facility in which the virtual robot R is set. The robot peripheral section only has to be a section that outputs information concerning the movement of the robot body section Ra in the periphery of the robot body section Ra. A dedicated logic circuit for separately setting the sampling time Tp and the interrupt time interval Ti variable in a range in which the sampling time Tp is equal to or smaller than the interval time interval Ti may be mounted on the robot simulation apparatus as a detachable chip. In other words, the robot simulation apparatus may have a configuration in which the functions of the robot simulation program are embodied as hardware.

The entire disclosure of Japanese Patent Application No. 2010-287873, filed Dec. 24, 2010 is expressly incorporated by reference herein.

What is claimed is:

1. A robot simulation apparatus for virtually moving a target to be simulated along a track, comprising:
a track calculating unit that calculates, in an interrupt time interval, a position of the target to be simulated after a sampling time, the sampling time being a time set for sampling the position of the target to be simulated and the interrupt time interval being a time set for calculating the position of the target to be simulated; and
a time changing unit that separately sets both of the sampling time and the interrupt time interval variable in a range in which the sampling time is equal to or shorter than the interrupt time interval.

2. The robot simulation apparatus according to claim 1, wherein
the time changing unit sets the sampling time to be equal to or shorter than a half of the interrupt time interval, and
the track calculating unit equalizes a number of times of the track calculation processing performed in the interrupt time interval and an integer part of a value obtained by dividing the interrupt time interval by the sampling time.

3. The robot simulation apparatus according to claim 2, wherein the time changing unit sets the sampling time and the interrupt time interval variable such that the interrupt time interval is an integer times as long as the sampling time.

4. The robot simulation apparatus according to claim 1, wherein
the virtual robot includes a robot body section, which is a target of the track calculation processing, and a robot peripheral section forming a periphery of the robot body section, and
the robot simulation apparatus further comprises an event processing unit that performs, for each the track calculation processing and following the track calculation processing, event processing for processing a grasp of a state with respect to the robot peripheral section as an event.

5. The robot simulation apparatus according to claim 4, wherein
the robot body section is plural arms coupled by joints, and
the robot peripheral section includes a robot hand coupled to a distal end of the robot body section, a camera that images the robot hand, and a sensor that detects a position of the robot hand.

6. A robot simulation method for virtually moving a target to be simulated along a track, comprising:
calculating, in an interrupt time interval, a position of the target to be simulated after a sampling time, the sampling time being a time set for sampling the position of the target to be simulated and the interrupt time interval being a time set for calculating the position of the target to be simulated; and
separately setting both of the sampling time and the interrupt time interval variable in a range in which the sampling time is equal to or shorter than the interrupt time interval.

7. A robot simulation program for causing a computer for moving a virtual robot along a track to function as:
a track calculating unit that performs, in an interrupt time interval, track calculation processing for calculating a track of the virtual robot after a sampling time; and
a time changing unit that separately sets both of the sampling time and the interrupt time interval variable in a range in which the sampling time is equal to or shorter than the interrupt time interval.
